(19) United States
(12) Patent Application Publication
(10) Pub. No.: US 2007/0185263 A1
(43) Pub. Date: Aug. 9, 2007

(54) COMPOSITION FOR FORMING SILICA-BASED COATING WITH A LOW REFRACTIVE INDEX

(75) Inventors: Yoshinori SAKAMOTO, Kanagawa (JP); Hiroyuki IIDA, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: TOKYO OHKA KOGYO CO., LTD., Kawasaki-shi (JP)

(21) Appl. No.: 11/671,413

(22) Filed: Feb. 5, 2007

(30) Foreign Application Priority Data
Feb. 7, 2006 (JP) 2006-030328

(51) Int. Cl. C08L 83/04; B32B 27/00

(52) U.S. Cl. 524/588

(57) ABSTRACT

Compositions for forming silica-based coatings are provided that can form lower refractive-index layers of protective films on lenses of solid image-pickup devices or on optical members such as light guides.

The compositions comprise a siloxane polymer and an alkyl quaternary amine. Such siloxane polymers are preferably utilized as hydrolysis products and/or partial condensates of at least one silane compound expressed by the formula (1) below:

RₙSiX₄₋ₙ (1)
in which each R represents independently a hydrogen atom or a monovalent organic group, X represents a hydrolyzable group, n is an integer of 0 to 2, and plural Rs may be identical or different from each other.

This application is based on and claims the benefit of priority from Japanese Patent Application No. 2006-030328, filed on 7 Feb. 2006, the content of which is incorporated herein by reference.

### BACKGROUND OF THE INVENTION

1. Field of the Invention

The present invention relates to compositions for forming silica-based coatings with a low refractive index, in particular to those capable of forming, for example, lower refractive-index layers of protective films on lenses of solid image-pickup devices or on optical members such as light guides.

2. Related Art

Layers with a low refractive index are typically formed on protective films of lenses of solid image-pickup devices or on light guides, for example. These layers with a low refractive index may be formed by CVD processes or coating processes. The coating processes are convenient compared to others; therefore, materials suitable for coating processes are in demand. Materials usable for these coating processes are disclosed in Patent Documents 1 and 2, for example.

Patent Document 1: Japanese Unexamined Patent Publication No. 2002-9266

Patent Document 2: Japanese Unexamined Patent Publication No. 2004-91579

However, the materials disclosed in the Patent Documents 1 and 2 suffer from insufficiently low refractive indices.

### SUMMARY OF THE INVENTION

In view of the circumstances described above, it is an object of the present invention to provide a composition for forming silica-based coatings with a low refractive index which provides a lower refractive index.

In order to attain the object described above, the composition according to the present invention comprises a siloxane polymer and an alkyl quaternary amine.

In another embodiment, the composition according to the present invention comprises a siloxane polymer, a heat-decomposable ingredient and a metal compound.

In still another embodiment, the composition according to the present invention comprises a siloxane polymer, a heat-decomposable ingredient and at least one selected from base generators and acid generators.

The term “low refractive index” as used herein means that the refractive index for light with wavelengths of 350 to 800 nm is no higher than 1.2.

The composition according to the present invention can form silica-based coatings with a low refractive index.

### DETAILED DESCRIPTION OF THE INVENTION

### First Embodiment

The composition for forming silica-based coatings with a low refractive index of the first embodiment comprises a siloxane polymer and an alkyl quaternary amine.

The siloxane polymer of the first embodiment is a polymer having a main skeleton of SiO units. The siloxane polymer is exemplified by a hydrolysis product and/or a partial condensate of at least one silane compound expressed by the formula (1) below:

RₙSiX₄₋ₙ (1)

in which each R represents a hydrogen atom or a monovalent organic group, X represents a hydrolyzable group, n is an integer of 0 to 2 and plural Rs may be identical or different from each other.

It is preferred that the compounds expressed by the general formula (1) include a compound of n=0, thereby mechanical strength may be increased. In the case of n=1 or 2, the R(s) is preferably a monovalent organic group.

The monovalent organic group of R described above may be organic groups having a carbon number of 1 to 20. Examples of the organic groups include alkyl groups such as methyl group, ethyl group and propyl group; alkenyl groups such as vinyl group, allyl group and propenyl group; aryl groups such as phenyl group and tolyl group; aralkyl groups such as benzyl group and phenylethyl group; epoxy-containing groups such as glycidyl group and glycidyloxy group; and amino-containing groups such as amino group and alkylamino group. Among these, those having a carbon number of 1 to 6 are preferable such as methyl group, ethyl group, propyl group and phenyl group, particularly preferable are methyl group and phenyl group, and most preferable is methyl group.

Examples of the hydrolyzable group X include alkoxy groups such as methoxy group, ethoxy group, propoxy group, isopropoxy group, butoxy group, sec-butoxy group and t-butoxy group; alkenoxy groups such as vinyloxy group and 2-propenoxy group; acyloxy groups such as phenoxy group and acetoxy group; oxime groups such as butanoxime group; amino groups. Among these, alkoxy groups having a carbon number of 1 to 5 are preferable, in particular methoxy group, ethoxy group isopropoxy group and butoxy group are preferable in view of easy control at hydrolysis and condensation.

The mass average molecular weight (Mw) of the reaction product, which does not have to be precisely defined, is preferably 1000 to 10000, more preferably 1000 to 5000 (gel permeation chromatography, calibrated with polystyrene standard).

Specific examples of the compounds expressed by the general formula (1) include trimethoxysilane, triethoxysilane, tri-n-propcxysilane, triisopropoxysilane, tri-n-butoxysilane, tri-sec-butoxysilane, tri-tert-butoxysilane, triphenoxysilane, fluorotrimethoxysilane, fluorotriethoxysilane, fluorotri-n-propoxysilane, fluorotriisopropoxysilane, fluorotri-n-butoxysilane, fluorotri-sec-butoxysilane, fluorotri-tert-butoxysilane, flouorotriphenoxysilane, tetramethoxysilane, tetraethoxysilane, tetra-n-propoxysilane, tetraisopropoxysilane, tetra-n-butoxysilane, tetra-sec-butoxysilane, tetra-tert-butoxysilane, tetraphenoxysilane, methyltrietethoxysilane, methyltriethoxysilane, methyltri-n-propoxysilane, methyltriisopropoxysilane, methyltri-n-butoxysilane, methyltri-sec-butoxysilane, methyltri-tert-butoxysilane, methyltriphenoxysilane, ethyltrimethoxysilane, ethyltriethoxysilane, ethyltri-n-propoxysilane, ethyltriisopropoxysilane, ethyltri-n-butoxysilane, ethyltri-sec-butoxysilane, ethyltri-tert-butoxysilane, ethyltriphenoxysilane, vinyltrimethoxysilane, vinyltriethoxysilane, vinyltri-n-propoxysilane, vinyltriisopropoxysilane, vinyltri-n-butoxysilane, vinyltri-sec-butoxysilane, vinyltri-tert-butoxysilane, vinyltriphenoxysilane, n-propyltrimethoxysilane, n-propyltriethoxysilane, n-propyltri-n-propoxysilane, n-propyltriisopropoxysilane, n-propyltri-n-butoxysilane, n-propyltri-sec-butoxysilane, n-propyltri-tert-butoxysilane, n-propyltriphenoxysilane, i-propyltrimethoxysilane, i-propyltriethoxysilane, i-propyltri-n-propoxysilane, i-propyltriisopropoxysilane, i-propyltri-n-butoxysilane, i-propyltri-sec-butoxysilane, i-propyltri-tert-butoxysilane, i-propyltriphenoxysilane, n-butyltrimethoxysilane, n-butyltriethoxysilane, n-butyltri-n-propoxysilane, n-butyltriisopropoxysilane, n-butyltri-n-butoxysilane, n-butyltri-sec-butoxysilane, n-butyltri-tert-butoxysilane, n-butyltriphenoxysilane, sec-butyltrimethoxysilane, sec-butyl-i-triethoxysilane, sec-butyltri-n-propoxysilane, sec-butyltri-iso-propoxysilane, sec-butyltri-n-butoxysilane, sec-butyltri-sec-butoxysilane, sec-butyltri-tert-butoxysilane, sec-butyltriphenoxysilane, t-butyltrimethoxysilane, t-butyltriethoxysilane, t-butyltri-n-propoxysilane, t-butyltri-iso-propoxysilane, t-butyltri-n-butoxysilane, t-butyltri-sec-butoxysilane, t-butyltri-tert-butoxysilane, t-butyltriphenoxysilane, phenyltrimethoxysilane, phenyltriethoxysilane, phenyltri-n-propoxysilane, phenyltriisopropoxysilane, phenyltri-n-butoxysilane, phenyltri-sec-butoxysilane, phenyltri-tert-butoxysilane, phenyltriphenoxysilane, vinyltrimethoxysilane, vinyltriethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-trifluoropropyltrimethoxysilane, gamma-trifluoropropyltriethoxysilane, dimethyldimethoxysilane, dimethyldiethoxysilane, dimethyldi-n-propoxysilane, dimethyldiisopropoxysilane, dimethyldi-n-butoxysilane, dimethyldi-sec-butoxysilane, dimethyldi-tert-butoxysilane, dimethyldiphenoxysilane, diethyldimethoxysilane, diethyldiethoxysilane, diethyldi-n-propoxysilane, diethyldiisopropoxysilane, diethyldi-n-butoxysilane, diethyldi-sec-butoxysilane, diethyldi-tert-butoxysilane, diethyldiphenoxysilane, di-n-propyldimethoxysilane, di-n-propyldiethoxysilane, di-n-propyldi-n-propoxysilane, di-n-propyldiisopropoxysilane, di-n-propyldi-n-butoxysilane, di-n-propyldi-sec-butoxysilane, di-n-propyldi-tert-butoxysilane, di-n-propyldiphenoxysilane, diisopropyldimethoxysilane, diisopropyldiethoxysilane, diisopropyldi-n-propoxysilane, diisopropyldiisopropoxysilane, diisopropyldi-n-butoxysilane, diisopropyldi-sec-butoxysilane, diisopropyldi-tert-butoxysilane, diisopropyldiphenoxysilane, di-n-butyldimethoxysilane, di-n-butyldiethoxysilane, di-n-butyl-di-n-propoxysilane, di-n-butyldiisopropoxysilane, di-n-butyldi-n-butoxysilane, di-n-butyldi-sec-butoxysilane, di-n-butyldi-tert-butoxysilane, di-n-butyldiphenoxysilane, di-sec-butyldimethoxysilane, di-sec-butyldiethoxysilane, di-sec-butyldi-n-propoxysilane, di-sec-butyldiisopropoxysilane, di-sec-butyldi-n-butoxysilane, di-sec-butyldi-sec-butoxysilane, di-sec-butyldi-tert-butoxysilane, di-sec-butyldiphenoxysilane, di-tert-butyldimethoxysilane, di-tert-butyldiethoxysilane, di-tert-butyldi-n-propoxysilane, di-tert-butyldiisopropoxysilane, di-tert-butyldi-n-butoxysilane, di-tert-butyldi-sec-butoxysilane, di-tert-butyldi-tert-butoxysilane, di-tert-butyldiphenoxysilane, diphenyldimethoxysilane, diphenyldiethoxysilane, diphenyldi-n-propoxysilane, diphenyldiisopropoxysilane, diphenyldi-n-butoxysilane, diphenyldi-sec-butoxysilane, diphenyldi-tert-butoxysilane, diphenyldiphenoxysilane, divinyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-trifluoropropyltrimethoxysilane and gamma-trifluoropropyltriethoxysilane. These may be used alone or in combination of two or more.

Preferable examples among the compounds of formula (1) described above are tetramethoxysilane, tetraethoxysilane, tetra-n-propoxysilane, tetraisopropoxysilane, tetraphenoxysilane, methyltrimethoxysilane, methyltriethoxysilane, methyltri-n-propoxysilane, methyltriisopropoxysilane, ethyltrimethoxysilane, ethyltriethoxysilane, vinyltrimethoxysilane, vinyltriethoxysilane, phenyltrimethoxysilane, phenyltriethoxysilane, dimethyldimethoxysilane, dimethyldiethoxysilane, diethyldimethoxysilane, diethyldiethoxysilane, diphenyldimethoxysilane, diphenyldiethoxysilane, trimethylmonomethoxysilane, trimethylmonoethoxysilane, triethylmonomethoxysilane, triethylmonoethoxysilane, triphenylmonomethoxysilane and triphenylmonoethoxysilane.

The compounds of the general formula (1) may be hydrolyzed or partially condensed through mixing with water and a catalyst in an organic solvent thereby to form a siloxane polymer. The organic solvent may be one as described later. The catalyst may be an organic acid, inorganic acid, organic base, inorganic base etc.

Examples of the organic acid include acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, 2-ethylhexanoic acid, oleic acid, stearic acid, linoleic acid, linolein acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, sulfonic acid, phthalic acid, fumaric acid, citric acid, tartaric acid, etc.

Examples of the inorganic acid include hydrochloric acid, nitric acid, sulfuric acid, hydrofluoric acid, phosphoric acid etc.

Examples of the organic base include methanolamine, ethanolamine, propanolamine, butanolamine, N-methylmethanolamine, N-ethylmethanolamine, N-propylmethanolamine, N-butylmethanolamine, N-methylethanolamine, N-ethylethanolamine, N-propylethanolamine, N-butylethanolamine, N-methylpropanolamine, N-ethylpropanylamine, N-propylpropanolamine, N-butylipropanolamine, N-methylbutanolamine, N-ethylbutanolamine, N-propylbutanolamine, N-butylbutanolamine, N,N-dimethylmethanolamine, N,N-diethylmethanolamine, N,N-dipropylmethanolamine, N,N-dibutylmethanolamine, N,N-dimethylethanolamine, N,N-diethylethanolamine, N,N-dipropylethanolamine, N,N-dibutylethanolamine, N,N-dimethylpropanolamine, N,N-diethylpropanolamine, N,N-dipropylpropanolamine, N,N-dibutylpropanolamine, N,N-dimethylbutanolamine, N,N-diethylbutanolamine, N,N-dipropylbutanolamine, N,N-dibutylbutanolamine, N-methyldimethanolamine, N-ethyldimethanolamine, N-propyldimethanolamine, N-butyldimethanolamine, N-methyldiethanolamine, N-ethyldiethanolamine, N-propyldiethanolamine, N-butyldiethanolamine, N-methyldipropanolamine, N-ethyldipropanolamine, N-propyldipropanolamine, N-butyldipropanolamine, N-methyldibutanolamine, N-ethyldibutanolamine, N-propyldibutanolamine, N-butyldibutanolamine, N-(aminomethyl)methanolamine, N-(aminomethyl)ethanolamine, N-(aminomethyl)propanolamine, N-(aminomethyl)butanolamine, N-(aminoethyl)methanolamine, N-(aminoethyl)ethanolamine, N-(aminoethyl)propanolamine, N-(aminoethyl)butanolamine, N-(aminopropyl)methanolamine, N-(aminopropyl)ethanolamine, N-(aminopropyl)propanolamine, N-(aminopropyl)butanolamine, N-(aminobutyl)methanolamine, N-(aminobutyl)ethanolamine, N-(aminobutyl)propanolamine, N-(aminobutyl)butanolamine, methoxymethylamine, methoxyethylamine, methoxypropylamine, methoxybutylamine, ethoxymethylamine, ethoxyethylamine, ethoxypropylamine, ethoxybutylamine, propoxymethylamine, propoxyethylamine, propoxypropylamine, propoxybutylamine, butoxymethylamine, butoxyethylamine, butoxypropylamine, butoxybutylamine, methylamine, ethylamine, propylamine, butylamine, N,N-dimethylamine, N,N-diethylanine, N,N-dipropylamine, N,N-dibutylamine, trimethylamine, triethylamine, tripropylamine, tributylamine, tetramethylammoniumhydroxide, tetraethylammoniumhydroxide, tetrapropylammoniumhydroxide, tetrabutylammoniumhydroxide, tetramethylethylenediamine, tetraethylethylenediamine, tetrapropylethylenediamine, tetrabutylethylenediamine, methylaminomethylamine, methylaminoethylamine, methylaminopropylamine, methylaminobutylamine, ethylaminomethylamine, ethylaminoethylamine, ethylaminopropylamine, ethylaminobutylamine, propylaminomethylamine, propylaminoethylamine, propylaminopropylamine, propylaminobutylamine, butylaminomethylamine, butylaminoethylamine, butylaminopropylamine, butylaminobutylamine, pyridine, pyrrole, piperazine, pyrrolidine, piperidine, picoline, morpholine, methylmorpholine, diazabicyclooctane, diazabicyclononane, diazabicycloundecene, etc.

Examples of the inorganic base include ammonia, sodium hydroxide, potassium hydroxide, barium hydroxide, calcium hydroxide, etc.

The amount of the catalyst may be adjusted such that the concentration is 1 to 1000 ppm, particularly 5 to 800 ppm in the reaction system of the hydrolysis reaction.

The additional amount of water is preferably 1.5 to 4.0 moles per one mole of hydrolysable groups of the entire compound expressed by the general formula (1).

In cases where the compound of the general formula (1) is hydrolyzed, the resulting alcohol and water in the presence are preferably removed. The removal of the alcohol yielded from the hydrolysis and the water may enhance the storage stability and film formability. The removal of alcohol and water is carried out by vacuum distillation. The vacuum distillation is carried out at a vacuum degree of 39.9×10² to 39.9×10³ Pa (about 30 to 300 mmHg), preferably at 66.5×10² to 26.6×10³ Pa (about 50 to 200 mmHg) and a temperature of 20 to 100 degrees C. The removal of the alcohol yielded from the hydrolysis and the water is carried out, for example, to no more than 10% by mass in the composition, preferably to no more than 5% by mass, more preferably to no more than 2% by mass.

The alkyl quaternary amine of this embodiment may be expressed by the formula (2). The alkyl quaternary amine may be used alone or in combinations of two or more.

R¹R²R³R⁴N⁺·K⁻ (2)

in which R¹, R², R³ and R⁴ are each independently a monovalent organic group, and K⁻ is a counter anion.

The organic groups R¹, R², R³ and R⁴ may be each independently those having a carbon number of 1 to 20.

Examples of the organic groups include linear, branched, monocyclic or condensed polycyclic alkyl groups such as methyl group, ethyl group, propyl group, butyl group, pentyl group, hexyl group, heptyl group, octyl group, nonyl group, decyl group, dodecyl group, octadecyl group, isopropyl group, isobutyl group, isopentyl group, sec-butyl group, t-butyl group, sec-pentyl group, t-pentyl group, t-octyl group, neopentyl group, cyclopropyl group, cyclobutyl, cyclopentyl group, cyclohexyl group, adamantyl group, norbornyl group, boronyl group and 4-decylcyclohexyl group; alkenyl groups such as vinyl group, allyl group and propenyl group; aryl groups such as phenyl group and tolyl group; and amino-containing groups such as amino group and alkylamino group.

The K⁻ may be alkylcarboxylic acid anions, arylcarboxylic acid anions or aralkylcarboxylic acid anions.

The alkyl of these anions may be linear, branched, monocyclic or condensed polycyclic alkyl groups having a carbon number of 1 to 30; examples thereof include methyl group, ethyl group, propyl group, butyl group, pentyl group, hexyl group, heptyl group, octyl group, nonyl group, decyl group, dodecyl group, octadecyl group, isopropyl group, isobutyl group, isopentyl group, sec-butyl group, t-butyl group, sec-pentyl group, t-pentyl group, t-octyl group, neopentyl group, cyclopropyl group, cyclobutyl, cyclopentyl group, cyclohexyl group, adamantyl group, norbornyl group, boronyl group and 4-decylcyclohexyl group.

The aryl of these anions may be monocyclic or condensed polycyclic aryl groups, having a carbon number of 4 to 18, which may contain a hetero atom; examples thereof include phenyl group, 1-naphtyl group, 2-naphtyl group, 9-anthryl group, 9-phenantolyl group, 2-furyl group, 2-thienyl group, 2-pyrrolyl group, 6-indolyl group, 2-benzofuryl group, 2-benzothienyl group, 4-quinolynyl group, 4-isoquinolynyl group, 2-carbazolyl group, 3-carbazolyl group, 4-carbazolyl group, 9-acrydinyl group, 3-phenothiadinyl group, 2-phenoxathiinyl group, 3-phenoxadinyl group and 3-thianthrenyl group.

The aralkyl of these anions may be aralkyl groups having a carbon number of 6 to 18; examples thereof include benzyl group, phenetyl group, naphthylmethyl group, anthrylmethyl group, naphthylethyl group, anthrylethyl group, etc.

The addition of these alkyl quaternary amines may lead to formation of silica-based coatings with a low refractive index.

It is also preferable that the alkyl quaternary amines have a decomposition temperature of no higher than 300 degrees C., more preferably no higher than 250 degrees C.; and the decomposition temperature is preferably no lower than 150 degrees C., more preferably no lower than 180 degrees C.

Preferable examples of the alkyl quaternary amines are lauryltrimethyl ammonium acetate, lauryltrimethyl ammonium chloride, hexadecyl ammonium acetate, etc, which may lead to formation of silica-based coatings with a low refractive index through convenient baking such as by a hot plate at no higher than 300 degrees C.

The amount of the alkyl quaternary amines is preferably 25 to 250% by mass, more preferably 50 to 200% by mass based on the solid content of coating liquids for forming silica-based coatings (converted mass of SiO₂).

It is preferred that the inventive composition contains a solvent such as organic solvents. Examples of the organic solvents include aliphatic hydrocarbon solvents such as n-pentane, i-pentane, n-hexane, i-hexane, n-heptane, i-heptane, 2,2,4-trimethylpentane, n-octane, i-octane, cyclohexane and methylcyclohexane; aromatic hydrocarbon solvents such as benzene, toluene, xylene, ethylbenzene, trimethylbenzene, methylethylbenzene, n-propylbenzene, i-propylbenzene, diethylbenzene, i-butylbenzene, triethylbenzene, di-i-propylbenzene, n-amylnaphthalene and trimethylbenzene; monoalcohol solvents such as methanol, ethanol, n-propanol, i-propanol, n-butanol, i-butanol, sec-butanol, t-butanol, n-pentanol, i-pentanol, 2-methylbutanol, sec-pentanol, t-pentanol, 3-methoxybutanol, n-hexanol, 2-methylpentanol, sec-hexanol, 2-ethylbutanol, sec-heptanol, heptanol, n-octanol, 2-ethylhexanol, sec-octanol, n-nonylalcohol, 2,6-dimethylheptanol, n-decanol, sec-undecylalcohol, trimethyl nonylalcohol, sec-tetradecylalcohol, sec-heptadecylalcohol, phenol, cyclohexanol, methylcyclohexanol, 3,3,5-trimethylcyclohexanol, benzyl alcohol, phenylmethylcarbinol, diacetone alcohol and cresol; multivalent alcohol solvents such as ethylene glycol, 1,2-propylene glycol, 1,3-butylene glycol, pentanediol, 2-methylpentanediol, 2,4-hexanediol, 2,5-heptanediol, 2-ethylhexanediol, diethyleneglycol, dipropyleneglycol, triethyleneglycol, tripropyleneglycol and glycerin; ketone solvents such as acetone, methylethylketone, methyl-n-propylketone, methyl-n-butylketone, diethylketone, methyl-1-butylketone, methyl-n-pentylketone, ethyl-n-butylketone, methyl-n-hexylketone, di-i-butylketone, trimethylnonanone, cyclohexanone, methylcyclohexanone, 2,4-pentanedione, acetonyl acetone, diacetone alcohol, acetophenone and fenchone; ether solvents such as ethylether, i-propylether, n-butylether, n-hexylether, 2-ethylhexylether, ethyleneoxide, 1,2-propyleneoxide, dioxolane, 4-methyldioxolane, dioxane, dimethyl dioxane, ethyleneglycolmonomethylether, ethyleneglycolmonoethylether, ethyleneglycoldiethylether, ethyleneglycolmono-n-butylether, ethyleneglycolmono-n-hexylether, ethyleneglycolmonophenylether, ethyleneglycolmono-2-ethylbutylether, ethyleneglycoldibutylether, diethyleneglycolmonomethylether, diethyleneglycolmonoethylether, diethyleneglycoldiethylether, diethyleneglycolmono-n-butylether, diethyleneglycoldi-n-butylether, diethyleneglycolmono-n-hexylether, ethoxytriglycol, tetraethyleneglycoldi-n-butylether, propyleneglycolmonomethylether, propyleneglycolmonoethylether, propyleneglycolmonopropylether, propyleneglycolmonobutylether, dipropyleneglycolmonomethylether, dipropyleneglycolmonoethylether, tripropyleneglycolmonomethylether, tetrahydrofuran and 2-methyl tetrahydrofuran; ester solvents such as diethylcarbonate, methyl acetate, ethyl acetate, gamma-butyrolactone, gamma-valerolactone, n-propyl acetate, i-propyl acetate, n-butyl acetate, i-butyl acetate, sec-butyl acetate, n-pentylacetate, sec-pentylacetate, 3-methoxybutyl acetate, methylpentylacetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethyleneglycol monomethylether acetate, ethyleneglycol monoethylether acetate, diethyleneglycol monomethylether acetate, diethyleneglycol monoethylether acetate, diethyleneglycol mono-n-butylether acetate, propyleneglycol monomethylether acetate, propyleneglycol monoethylether acetate, propyleneglycol monopropylether acetate, propyleneglycol monobutylether acetate, dipropyleneglycol monomethylether acetate, dipropyleneglycol monoethylether acetate, glycol diacetate, methoxytriglycol acetate, ethyl propionate, n-butyl propionate, i-amyl propionate, diethyl oxalate, di-n-butyl oxalate, methyl lactate, ethyl lactate, n-butyl lactate, n-amyl lactate, diethyl malonate, dimethyl phthalate and diethyl phthalate; nitrogen-containing solvents such as N-methylformamide, N,N-dimethylformamide, N,N-diethylformamide, acetamide, N-methyl acetamide, N,N-dimethyl acetamide, N-methylpropionamide and N-methylpyrrolidone; sulfur-containing solvents such as dimethyl sulfide, diethyl sulfide, thiophene, tetrahydrothiophene, dimethylsulfoxide, sulfolane and 1,3-propane sultone. These may be used alone or in combinations of two or more.

There is no set limit on the amount of the solvents used in the present invention; preferably, the amount is adjusted such that the concentration of total solid content is about 1 to 30% by mass in the composition, more preferably about 5 to 25% by mass. The concentration range may lead to an appropriate range of film thickness of the coated film and also excellent storage stability.

It is preferred that propyleneglycol monomethylether acetate (PGMEA), propyleneglycol propylether (PGP), 3-methoxybutyl acetate, n-butanol (BuOH), methylethylketone, acetone, butyl acetate, propyleneglycol dimethylether or isopropyl alcohol is utilized for the solvent. These solvents are preferably 1 to 100% by mass based on the total solvents, more preferably about 5 to 30% by mass.

Among these, 3-methoxybutyl acetate, methylethylketone and acetone may improve the storage stability of the composition and prevent gelatinization thereof. PGMEA, PGP and BuOH may improve the coating properties and uniformity. Combinations of these solvents may also provide these properties.

Surfactants may be added to the inventive composition for forming silica-based coatings in order to improve the coating properties or to prevent striations. Examples of the surfactants include nonionic surfactants, anionic surfactants, cationic surfactants and amphoteric surfactants, and also silicone surfactants, polyalkyleneoxide surfactants and poly(meth)acrylate surfactants.

### Second Embodiment

In the second embodiment, the composition for forming silica-based coatings with a low refractive index comprises a siloxane polymer, a heat-decomposable ingredient and a metal compound. That is, the constitution of the second embodiment is the same as that of the first embodiment except that the alkyl quaternary amine in the first embodiment is replaced by the heat-decomposable ingredient and the metal compound.

The composition of this embodiment comprises the heat-decomposable ingredient. The heat-decomposable ingredient may have one component or two or more components.

The term “heat-decomposable ingredient” means that the ingredient can be decomposed by heating to make the silica-based coating porous. The upper limit of the decomposition temperature is preferably no higher than 300 degrees C., more preferably no higher than 250 degrees C.; and the decomposition temperature is preferably no lower than 150 degrees C., more preferably no lower than 180 degrees C.

The heat-decomposable ingredient may be polyalkylene glycols or end-alkylated products thereof; monosaccharides, disaccharides or polysaccharides of 1 to 22 hexose derivatives or their derivatives, or self-decomposable gas-generating organic peroxides such as benzoyl peroxide.

The carbon number of alkylene groups of the polyalkylene glycols is preferably 1 to 5, more preferably 1 to 3; examples thereof are lower alkylene glycols such as polyethylene glycols and polypropylene glycols.

The end-alkylated products of polyalkylene glycols are those where the hydroxide group at either or both ends of the polyalkylene glycols are alkoxylated by an alkyl group. The alkyl group of the end-alkylated products may be linear or branched, and the carbon number thereof is preferably 1 to 5, more preferably 1 to 3. The alkyl group is preferably a linear one such as methyl group, ethyl group and propyl group.

It is preferred that the mass average molecular weight (Mw) of the polyalkylene glycols and end-alkylated products thereof is 100 to 10000, more preferably 200 to 5000, still more preferably 400 to 4000. The upper limit of the range of Mw may lead to proper coating properties without impairing compatibility of coating liquids and appropriate film-thickness uniformity of silica-based coatings. The lower limit of the range can make the silica-based coatings porous, thus allowing lower permittivity.

The amount of the heat-decomposable ingredient is preferably 25 to 250% by mass, more preferably 50 to 200% by mass based on the solid content of coating liquids (converted mass of SiO₂)

The composition of this embodiment comprises a metal compound. The metal compound may have one component or two or more components. The metal compound can lower the permittivity, improve the electrical properties and enhance the film-thickness uniformity of silica-based coatings formed from the composition for forming silica-based coatings.

In addition, it may provide the effects that the storage stability of the composition may be improved and degasification of the composition may also be suppressed.

The metal of the metal compounds may be alkali metals, alkaline earth metals etc.; among these, monovalent alkali metals are preferable. More specifically, sodium, lithium, potassium, rubidium, cesium etc. are exemplified; among these, rubidium and cesium are preferable in particular.

These metal compounds may be organic acid salts, inorganic acid salts, alkoxides, oxides, nitrides, halides such as chlorides, bromides, fluorides and iodides; and hydroxides of these metals, for example.

Examples of the organic acids include formic acid, oxalic acid, acetic acid, propionic acid, butyric acid, valeric acid, caproic acid, heptanoic acid, 2-ethylhexanoic acid, cyclohexane acid, cyclohexapropionic acid, cyclohexaneacetic acid, nonanoic acid, malic acid, glutamic acid, leucic acid, hydroxypivalic acid, pivalic acid, glutaric acid, adipic acid, cyclohexanedicarboxylic acid, pimelic acid, cork acid, ethylbutyric acid, benzoic acid, phenylacetic acid, phenylpropionic acid, hydroxybenzoic acid, caprylic acid, lauric acid, myristic acid, palmitic acid, stearic acid, araginic acid, oleic acid, elaidic acid, linoleic acid and ricinoleic acid.

Examples of the inorganic acids include nitric acid, sulfuric acid, hydrochloric acid, carbonic acid and phosphoric acid. Examples of the alkoxides include methoxide, ethoxide, propoxide and butoxide.

The metal compounds are preferably inorganic acid salts or halides, in particular nitrate salts. The metal compound is preferably rubidium nitrate in particular.

The content of these metal compounds is preferably 1 to 15% by mass, more preferably 5 to 10% by mass based on the siloxane polymer (solid content (converted mass of SiO₂)) in the composition for forming silica-based coatings.

The addition of the heat-decomposable ingredients and the metal compounds into the composition may attain sufficiently low refractive indices.

### Third Embodiment

The composition of this embodiment comprises a siloxane polymer, a heat-decomposable ingredient, and at least one selected from base generators and acid generators.

That is, the constitution of the third embodiment is the same as that of the first and second embodiments except that the metal compound in the second embodiment is replaced with one selected from base generators and acid generators.

Examples of the base generators include guanidine trichloroacetate, methylguanidine trichloroacetate, potassium trichloroacetate, guanidine phenylsulfonylacetate, guanidine p-chlorophenylsulfonylacetate, guanidine p-methanesulfonylphenylsulfonylacetate, potassium phenylpropiolate, guanidine phenylpropiolate, cesium phenylpropiolate, guanidine p-chlorophenylpropiolate, guanidine p-phenylene-bis-phenylpropiolate, tetramethylammonium phenylsulfonylacetate, tetramethylammonium phenylpropiolate, 2-nitrobenzyl-N-cyclohexylcarbamate, triphenylsulfoniumhydroxide, anisoin-N-cyclohexylcarbamate nifedipine, N-t-butoxycarbonyl-2-phenylbenzimidazole, N-t-butoxycarbonyldicyclohexylamine, N-(2-nitrobenzyloxycarbonyl)imidazole, N-(3-nitrobenzyloxycarbonyl)imidazole, N-(4-nitrobenzyloxycarbonyl) imidazole, N-(5-methyl-2-nitrobenzyloxycarbonyl)imidazole and N-(4-chloro-2-nitrobenzyloxycarbonyl)imidazole. Among these, preferable base generators generate a base at no higher than 300 degrees C., more preferably at no higher than 250 degrees C.; preferably, the base generators generate a base at no lower than 150 degrees C., more preferably at no lower than 180 degrees C.

Examples of the acid generators include triazine halides, ammonium salts of acids, onium salts, sulfonated esters, substituted hydroxyimides, substituted hydroxylimines, azides, naphthoquinones such as diazonaphthoquinones, and diazo compounds. Among these, preferable acid generators generate an acid at no higher than 300 degrees C., more preferably at no higher than 250 degrees C.; preferably, the acid generators generate an acid at no lower than 150 degrees C., more preferably at no lower than 180 degrees C.

The content of these base generators or acid generators is preferably 1 to 15% by mass, more preferably 5 to 10% by mass based on the siloxane polymer (solid content (converted mass of SiO₂)) in the composition for forming silica-based coatings.

The ingredients of the heat-decomposable ingredient and at least one selected from base generators and acid generators may make it possible for the composition to attain sufficiently lower refractive indices.

### Method for Forming Silica-Based Coatings with a Low Refractive Index

The following methods may be exemplified for forming the silica-based coatings with a low refractive index from the inventive composition.

A coating film is initially formed on a substrate such as base materials in a predetermined thickness of the composition by way of a coating process such as rotary coating, flow casting coating and roll coating processes. The thickness of the coating film may be properly selected.

The coating film is then baked on a hot plate. This bake treatment evaporates the organic solvent in the coating film and cause a reaction between molecules of the siloxane polymer and thus promote the polymerization. The bake temperature at this treatment is about 80 to 300 degrees C. for example, more preferably about 80 to 250 degrees C. This bake treatment may be carried out in plural steps (multiple bake) with different bake temperatures. Consequently, a silica-based coating with a low refractive index may be obtained.

With the composition described above, the silica-based coating may be formed through the bake even at a temperature of no higher than 300 degrees C., that is, the bake at lower temperatures may be made possible. In addition, a period of 1 to 2 minutes is sufficient for the bake, which may make it possible to enhance the productivity.

### EXAMPLES

### Example 1

Twenty one grams of n-butanol, 3 g of pure water and 2 g of lauryltrimethyl ammonium acetate were mixed and dissolved, to which 200 μL of nitric acid was further added to prepare a solution, then 1.9 g of orthoethyl silicate and 1.7 g of methyltriethoxysilane were mixed with the solution to react for two days. Consequently, a composition for forming silica-based coatings was obtained.

The composition for forming silica-based coatings was coated on a glass substrate using a spin coater (by Tazmo Co.) to form a coating film. Then the coating film was multiple-baked on a hot plate at 80 degrees C. for 2 minutes, 150 degrees C. for 2 minutes and 300 degrees C. for 2 minutes thereby to form a silica-based coating. The resulting silica-based coating had a refractive index of 1.18.

### Example 2

A total of 367.7 g of methyltrimethoxysilane, 411.0 g of tetramethoxysilane, and 1381 g of a mixture solvent of acetone/isopropyl alcohol (½) were mixed and stirred, to which 340.2 g of pure water and 58.9 μL of nitric acid with 60% by mass concentration were added, and stirred to cause a hydrolysis reaction. Thereafter the concentration of the solid content was adjusted to 7% by mass through concentrating the reactant thereby to prepare a base coating liquid A.

Twenty eight grams of the base coating liquid A, 3 g of polypropylene glycol (by Sanyo Chemical Industries, Ltd., product name: Newpol PP-1000, mass average molecular weight: 1000) and 2 g of rubidium nitrate were mixed to prepare a composition for forming silica-based coatings.

A silica-based coating was formed from the composition for forming silica-based coatings in a similar manner as Example 1. The silica-based coating had a refractive index of 1.19 for light with wavelengths of 350 to 800 nm.

### Example 3

Twenty eight grams of the base coating liquid A, 3 g of polypropylene glycol (by Sanyo Chemical Industries, Ltd., product name: Newpol PP-1000, mass average molecular weight: 1000) and 2 g of 2-nitrobenzyl-N-cyclohexylcarbamate (by Midori Kagaku Co., product name: NBC-101) were mixed to prepare a composition for forming silica-based coatings.

A silica-based coating was formed from the composition for forming silica-based coatings in a similar manner as Example 1. The silica-based coating had a refractive index of 1.18.

### Comparative Example 1

Twenty eight grams of the base coating liquid A and 1 g of polypropylene glycol (by Sanyo Chemical Industries, Ltd., product name: Newpol PP-1000, mass average molecular weight: 1000) were mixed to prepare a composition for forming silica-based coatings.

The composition for forming silica-based coatings was coated on a glass substrate using a spin coater (by Tazmo Co.) to form a coating film. Then the coating film was multiple-baked on a hot plate at 80 degrees C. for 1 minute, 150 degrees C. for 1 minute and 200 degrees C. for 1 minute thereby to form a silica-based coating. The resulting silica-based coating had a refractive index of 1.35.

### Comparative Example 2

Twenty eight grams of the base coating liquid A and 3 g of polypropylene glycol (by Sanyo Chemical Industries, Ltd., product name: Newpol PP-1000, mass average molecular weight: 1000) were mixed to prepare a composition for forming silica-based coatings.

A silica-based coating was formed from the composition for forming silica-based coatings in a similar manner as Example 1. The silica-based coating had a refractive index of 1.23. FT-IR analysis of this silica-based coating showed a peak of Si—O—Si smaller than that of Example 2, that is, the bond was formed to a lesser degree.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A composition for forming silica-based coatings with a low refractive index, comprising a siloxane polymer and an alkyl quaternary amine.

2. The composition according to claim 1, wherein the alkyl quaternary amine has a decomposition temperature of no higher than 300 degrees C.

3. The composition according to claim 1, wherein the siloxane polymer comprises a hydrolysis product and/or a partial condensate of at least one silane compound expressed by the formula (1) below:
RₙSiX₄₋ₙ (1)
in which each R represents independently a hydrogen atom or a monovalent organic group, X represents a hydrolyzable group, n is an integer of 0 to 2 and plural Rs may be identical or different from each other.

4. A composition for forming silica-based coatings with a low refractive index, comprising a siloxane polymer, a heat-decomposable ingredient and a metal compound.

5. The composition according to claim 4, wherein the metal compound is an alkali metal compound.

6. The composition according to claim 4, wherein the heat-decomposable ingredient is an organic polymer having a decomposition temperature of no higher than 300 degrees C.

7. The composition according to claim 4, wherein the siloxane polymer comprises a hydrolysis product and/or a partial condensate of at least one silane compound expressed by the formula (1) below:
RₙSiX₄₋ₙ (1)
in which each R represents independently a hydrogen atom or a monovalent organic group, X represents a hydrolyzable group, n is an integer of 0 to 2 and plural Rs may be identical or different from each other.

8. A composition for forming silica-based coatings with a low refractive index, comprising a siloxane polymer, a heat-decomposable ingredient, and at least one selected from base generators and acid generators.

9. The composition according to claim 8, wherein the heat-decomposable ingredient is an organic polymer having a decomposition temperature of no higher than 300 degrees C.

10. The composition according to claim 8, wherein the siloxane polymer comprises a hydrolysis product and/or a partial condensate of at least one silane compound expressed by the formula (1) below:
RₙSiX₄₋ₙ (1)
in which each R represents independently a hydrogen atom or a monovalent organic group, X represents a hydrolyzable group, n is an integer of 0 to 2 and plural Rs may be identical or different from each other.
